(19) United States
(12) Patent Application Publication
(10) Pub. No.: US 2014/0359465 A1
(43) Pub. Date: Dec. 4, 2014

(54) Method and Apparatus for Annotated Electronic File Sharing

(71) Applicant: Nubo Software Ltd., Airport City (IL)

(72) Inventors: Anat Litan Sever, Kiryat Ono (IL); Israel Lifshitz, Ganei Tlkva (IL); Asi Mugrabi, Bat-Yam (IL)

(73) Assignee: Nubo Software Ltd., Airport City (IL)

(21) Appl. No.: 14/293,374

(22) Filed: Jun. 2, 2014

Related U.S. Application Data
(60) Provisional application No. 61/829,521, filed on May 31, 2013.

(51) Int. Cl. G06F 17/30; G06F 3/0484; G06F 3/0481

(52) U.S. Cl. CPC G06F 17/30126; G06F 3/04817; G06F 3/04842
USPC 715/738

(57) ABSTRACT

A method and apparatus for sharing electronic documents and sharing annotations to the same is disclosed. In some aspects, the present teachings include easy to use and flexible user interface elements to assist users in accessing shared files and folders as well as indications to alert the users to updates in the condition of a shared item. The user interface also permits simple but effective sharing of comments relating to content and allows for intuitive social networking features in the context of electronic content sharing. In other aspects, an indicator of how many new unread comments are associated with a shared electronic file exist is placed visually on or beside the actual icon of the share electronic file associated with the comments.

### RELATED APPLICATIONS

The present application is related to and claims priority under 35 USC 120 to U.S. Provisional Application No. 61/829,521 entitled “Method and Apparatus for Annotated Electronic File Sharing”, filed on May 31, 2013, which is hereby incorporated by reference.

### TECHNICAL FIELD

The present disclosure generally relates to the sharing of electronic files. More specifically, relating to the sharing of electronic documents or collections of documents accompanied.

### BACKGROUND

Numerous examples of file sharing applications exist today. Typically, an originator of a file to be shared places the electronic file into a storage location accessible to the file sharing application or service. The originator of the shared file then specifies one or more persons with whom he or she wishes to share the file, after which the service delivers a notification message to one or more recipients with which the files are to be shared. Most commonly, the notifications arrive in the form of electronic mail messages (email) or a similar written notification. The recipient, usually also a subscriber to the file sharing service, indicates his or her acceptance of the offer to share the files and proceeds to download or access a copy of the files that were shared.

In addition, file sharing services may provide notifications to the subscribers sharing a given file whenever the given file has been amended or edited or changed. Also, some file sharing services permit subscribers to make annotations accompanying the shared files, which other subscribers sharing the file can read and can comment on in turn.

FIG. 1 illustrates an exemplary interface of a typical file sharing service 10 according to the prior art. The interface shows one or more folders including at least one folder 100 that is shared with other collaborators or subscribers to the service. A person controlling the sharing attributes of folder 100 may do so using a simple set of tools 110 that are predefined by the file sharing service provider. Deopbox® and Box.net® and other services offer the ability for a group of users to access and interact with a shared file or folder. Such systems and services lack a rich feature base and do not accommodate useful user experience functionality or social networking features.

Other prior art methods and systems for sharing electronic content require the sending and receiving of messages relating to the status of the changed thing. Some operating systems (e.g., the Apple iOS) include user interfaces that have icons associated with applications such as the electronic mail (email) application. The icons associated with the applications can change their appearance to indicate new messages or unread messages waiting in an email inbox or text message application for example. However, these icons and techniques are indicative of updates (unread comments) generally to the application overall (e.g., Mail application showing number of unread emails) and not indicative of shared comments associated with a specific shared electronic file that can be updated or interactively annotated.

To the extent that prior systems were capable of sharing commentary among shared users of a file, this has disadvantages. The conventional way of commenting to a shared file requires modification of the file itself by embedding the comments into the file (such as with Google Drive Chat and Microsoft Word “Track Changes”) thus complicating and altering the shared file. In the Google Drive example, a group of members can share a document and leave comments for each other in the document. A chat box is presented in the shared document and the members can see and add comments to the document. This in-document commentary detracts from the document and limits the commentary and limits the type of file the comments can be associated with. Furthermore, in the Google example, the notifications regarding shared comments appear in the notification bar of a mobile device (e.g., a bar at the top of the phone screen similar to how a notification of a new email or text message may appear), which is not ideal for associating shared comments dynamically with specific files or folder objects.

Therefore, current file sharing applications and services lack a clear and useful user experience or user interface for exchanging comments relating to particular files, folders and data objects. Current systems also lack the ability to integrate the file sharing service with desired social networking experiences in real time and do not provide an adequate real time collaboration capability.

### SUMMARY

The present disclosure provides methods and systems for sharing electronic content. In some aspects, the present teachings include easy to use and flexible user interface elements to assist users in accessing shared files and folders as well as indications to alert the users to updates in the condition of a shared item. The user interface also permits simple but effective sharing of content and allows for intuitive social networking features in the context of electronic content sharing.

One embodiment is directed to a system for sharing an electronic file comprising a visual display unit including a visual display area for displaying a user interface; a portion of said visual display area including a display of an icon of a shared electronic file; wherein said portion of said visual display area further displays a visual indicator of a sharing status of said electronic file or folder; and wherein said indicator of said sharing status visually indicates a quantity of unread comments specifically associated with said shared electronic file.

Another embodiment is directed to a method for sharing electronic content and comments made specifically relating to shared electronic files comprising displaying on a portion of a visual display unit an icon representing an electronic file being shared by a plurality of users; displaying on said display unit an indicator of a sharing status of said electronic file; and displaying on said display unit an indicator of a quantity of unread comments specifically associated with said electronic file.

Yet another embodiment is directed to a method for notification regarding comments associated with a shared electronic file, comprising establishing a data structure at a server, the data structure indicative of at least one shared electronic file shared among a plurality of client users and data relating to comments specifically associated with said shared electronic file; receiving a comment from a first client, said comment containing comment content information and comment time stamp information specifically associated with said shared electronic file; receiving from a second client a counter update request requesting a number of unread comments specifically associated with said shared electronic file; sending to said second client a signal indicative of a number of said unread comments specifically associated with said shared electronic file; receiving from said second client a request for at least said content information specifically associated with said shared electronic file; sending to said second client said comment content information specifically associated with said shared electronic file; and updating said data structure regarding said comments specifically associated with said shared electronic file to indicate that said comment content information was sent to said second client.

### BRIEF DESCRIPTION OF THE DRAWINGS

For a fuller understanding of the nature and advantages of the present concepts, reference is made to the following detailed description of preferred embodiments and in connection with the accompanying drawings, in which:

FIG. 1 illustrates a conventional file sharing interface according to the prior art;

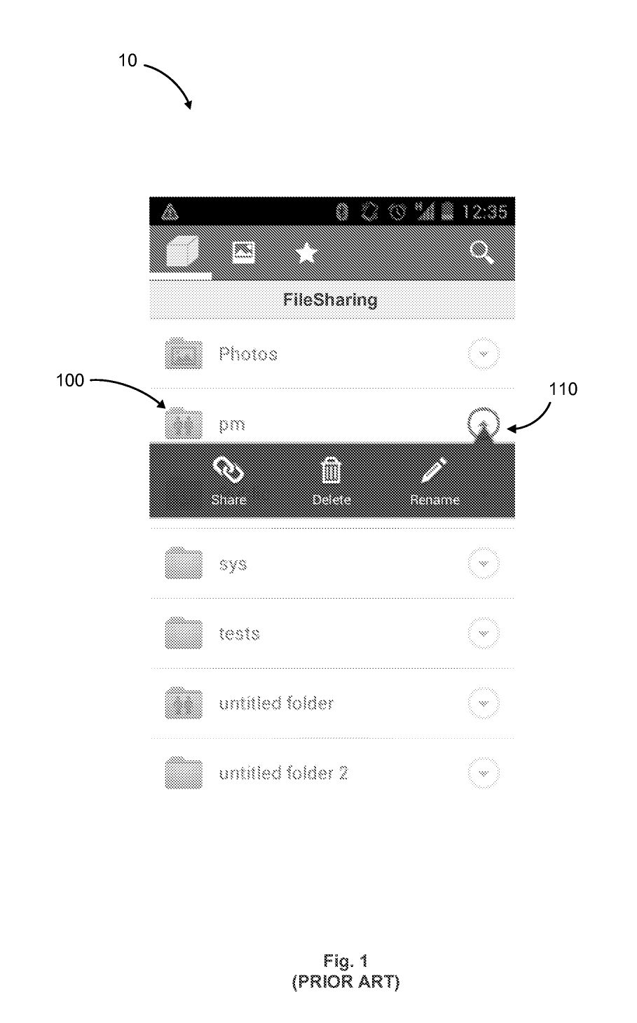

FIG. 2 illustrates an exemplary file sharing user interface according to an embodiment to the present invention;

FIG. 3 illustrates an exemplary architecture for file sharing according to the present invention;

FIG. 4 illustrates an exemplary shared folder having an annotated comment associated there with;

FIG. 5 illustrates an exemplary shared folder in a user interface according to the present invention;

FIG. 6 illustrates two different types of files shared and annotated according to embodiments of the present invention;

FIG. 7 illustrates an exemplary user interface for sharing a electronic file and annotating the same according to an embodiment the present invention;

FIG. 8 illustrates an exemplary user interface of the present file sharing system where an owner of a file has shared content with other users and provided the users with annotated comments related to the same;

FIG. 9 illustrates an exemplary arrangement for user device environments in connection over a network;

FIG. 10 illustrates a simplified client-server architecture for implementing the invention;

FIG. 11 illustrates client-side user application modules;

FIG. 12 illustrates server-side application server modules; and

FIG. 13 illustrates exemplary data structures.

### DETAILED DESCRIPTION

In various aspects the present invention provides a more useful and useable electronic file sharing method and system. The present aspects include new and useful user experience features implements in computer readable instructions or program code that may be executed on processors or other computer hardware having access to said stored instructions. Those skilled in the art would appreciate that various implementations of the present concepts may be achieved depending on a specific desired implementation or end product. In various examples, the present method and system is carried out on one or more computers, mobile communication devices, servers, database or memory storage units and associated peripherals and network connectivity devices.

A particular aspect of a well-featured user experience includes a user interface by which a human user can interact with the system. Computer input/output (I/O) including user interface instrumentalities such as keyboards mouse pointers display units and other audiovisual interface accessories are used in various embodiments of the present method and system.

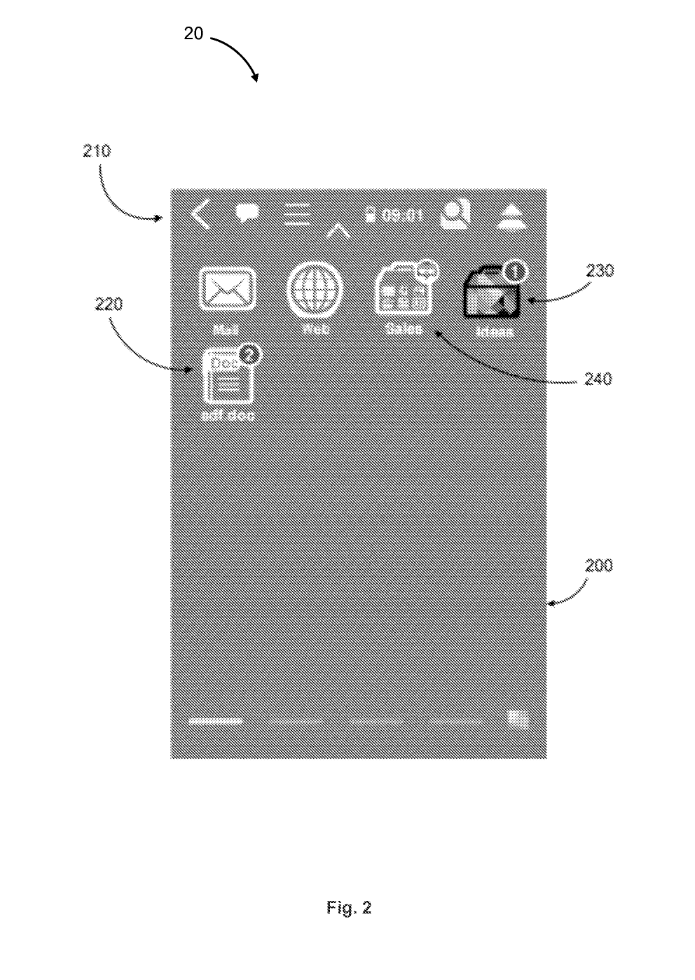

FIG. 2 illustrates an exemplary user interface 20 in an electronic file sharing system. The user interface 20 includes a portion of a visual display unit 200 that depicts on the image pixels of the display various icons and use interface features. Specifically, and by way of example as shown, a row of user interface features 210 may be presented in a portion of the display 200. In addition, one or more icons representing applications, files or folders may also be displayed on the display 200. In this example, which can be generalized by those skilled in the art, a document 220 is shown through its icon as well as a folder 240 containing documents or other electronic media or content, which in this example is shared with other users. An icon 230 representing a collection of electronic documents having readable annotated notes associated there with is also shown displayed on the systems display 200.

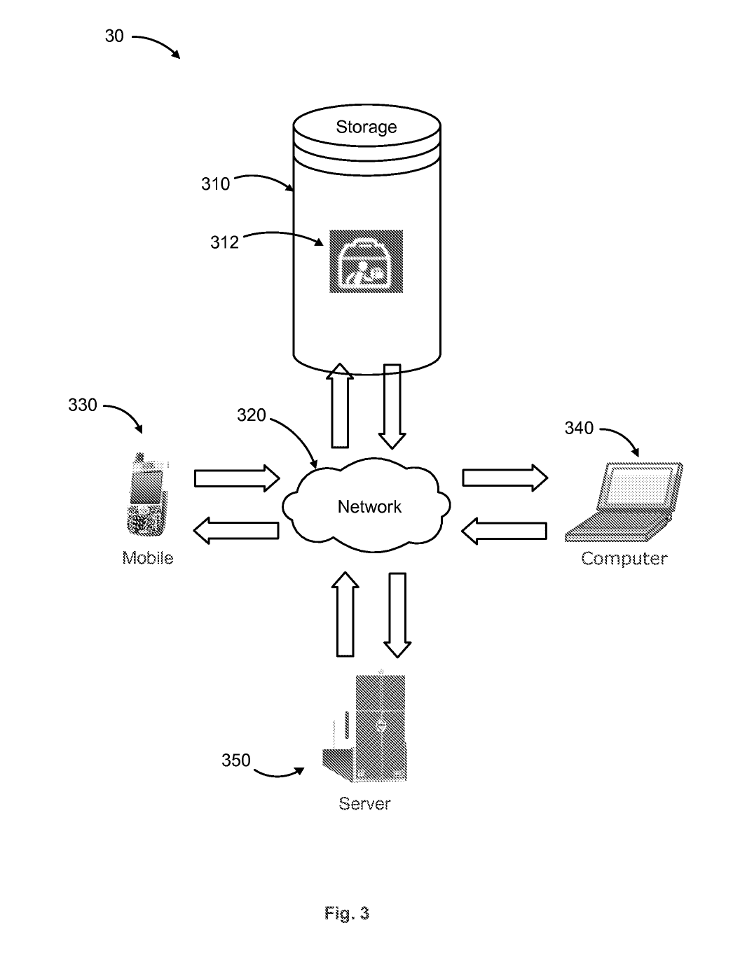

As mentioned earlier, various architectures may be employed to implement the current method and system. FIG. 3 illustrates an exemplary arrangement or architecture for carrying out the present invention. Other implementations and arrangements would become apparent to those skilled in the art and are comprehended by the following disclosure. In the present example, a network 320 interconnects various components that may send or receive data over the network. A computer 340 such as a personal computer or a laptop or a desktop computing machine is coupled through a communication interface to the network 320. In addition, a mobile device 330 such as a smart phone, tablet, personal digital assistant may communicate through wired or wireless means with the network 320. Additionally, a server 350 and a storage medium or database 310 including electronic files presented in an inbox 312 may be stored and coupled to the network and therefore to the other components connected to the network. It should be understood that each of the computing systems 340, 330, and 350 may also themselves include various processing circuits and memory and digital data storage devices therein. The arrangement depicted in exemplary system 30 is meant to convey the notion of data and files being exchanged or shared as well as annotations relating to those files being stored and shared among a plurality of users or machines.

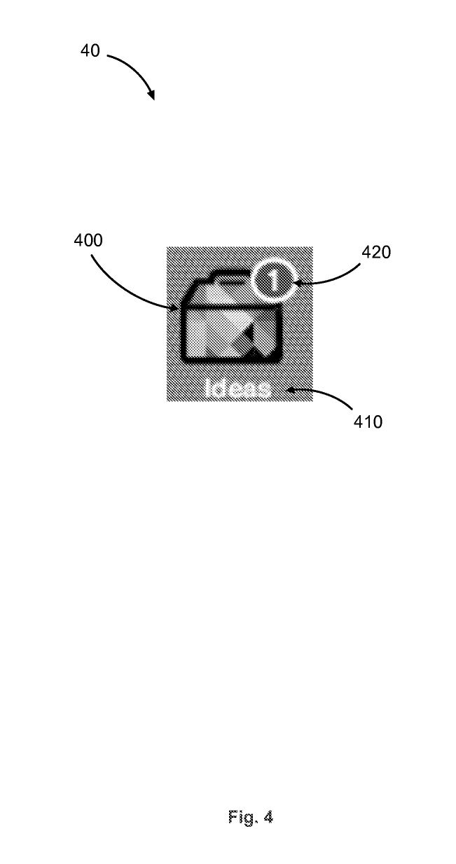

FIG. 4 is presented as an exemplary display of a shared electronic document or collection of documents. The figure may be a portion of a representation in a user interface as described earlier. This portion of a viewable user interface 40 may include a visual representation of a folder, suitcase or other repository of electronic content 400 (represented by an icon). The folder 400 may be represented such an icon and may be associated with a name 410 given to the folder or the collection of electronic documents being shared. An indication 420 shows in this exemplary embodiment how the system displays to a user that there is a message or annotation 420 associated with the contents of folder 400.

In some embodiments, the indication 420 shows the number of unread messages available to the user relating to the icon of folder or file 400, which is generally a repository of electronic content represented by an icon. In an aspect, the number of unread messages waiting for a user to access them (by reading if they are readable or listening if they are audible, etc.) is dynamically updated. The number of new messages relating to the repository 400 can be updated in real time. In another aspect, once the user accesses his or her messages relating to a repository 400, the message counter 402 indicator can be reset to zero (“0”) or can be erased/deleted while there are no unread messages to attend to. The indicator 402 can re-appear or the count indicated in it can resume at one (“1”) once a first unread message is posted for the user's attention, and continues to count upwards as further messages are posted to the user relating to the file or folder 400.

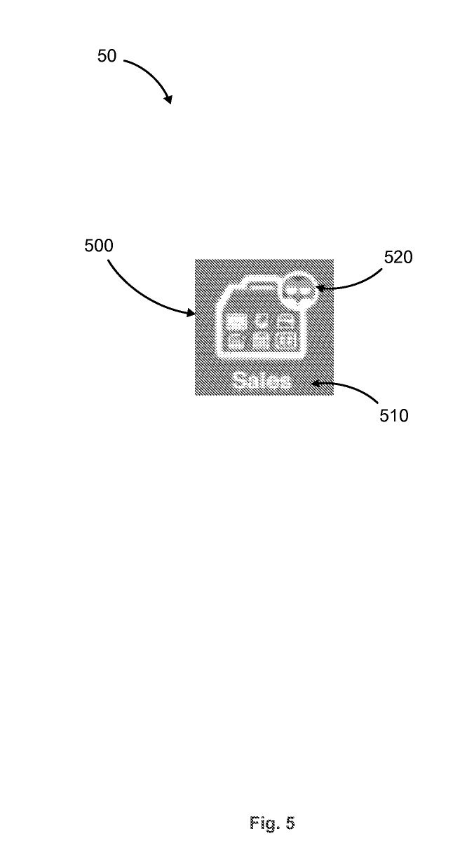

FIG. 5 illustrates another portion 50 of a user interface such as a portion of a user interface display screen as described earlier. The portion 50 may include a plurality of files within a folder 500 as mentioned previously. The collection of files in folder 500 may be collectively referred to by a name associated with the folder and such name 510 being displayed proximal to an icon of the folder 500. A visual indication 520 such as the one shown in this example indicates that the folder 500 is shared with other users.

In some embodiments, the user can interact with the system through the user interface as described and appreciated by those of skill in the art. In an aspect, the user can review the messages associated with a data repository such as a file or a folder by activating the message indicator symbol corresponding to the same. For example, the user can click on the new message indicator to bring up the unread messages associated with a repository (by using a computer mouse or by tapping or double-tapping with a stylus or finger tip, etc.). Doing so may reset the number of unread messages for that object to zero (“0”). In an example, as shown, the message indicator is at a corner of its corresponding object's icon (e.g., at an upper right corner).

As mentioned, once the user brings up the message box associated with a shared data object, the user can then also add a new comment about the object so that other users who share this object can see this new comment on their systems. If the object is shared with more than one other user, the comment sharing indicators on each of the more than one other users' interfaces will be updated to reflect that a new comment has been shared. The mechanism for updating the comment counter indication can be achieved using a counter update request to an application server, which responds to the client with an updated count of the number(s) of unread waiting messages for each content repository (file, folder, object) shared with the respective user. Various data structures supporting exemplary ways of storing and depicting the information to track new and read messages are described in more details further on below.

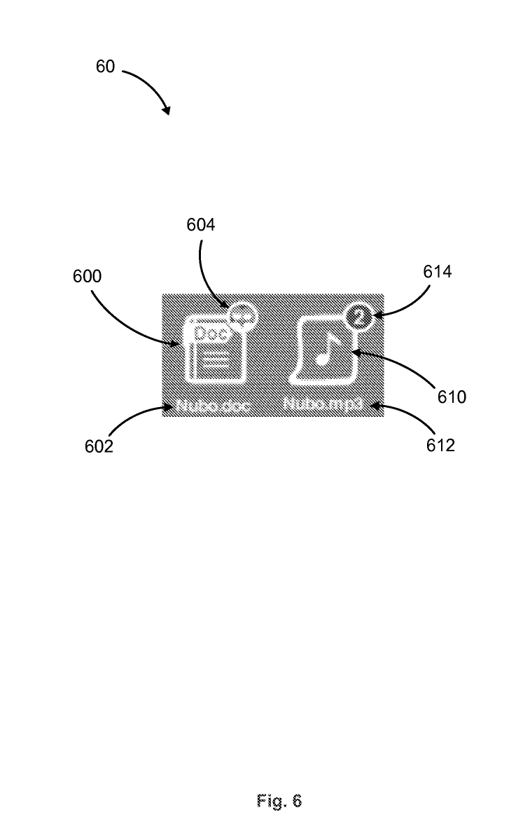

FIG. 6 illustrates another exemplary portion 60 of a display in a user interface according to an embodiment of the present system. The display portion 60 shows a document 600 having a name 602 which may optionally indicate the type of document (for example .doc) also, as mentioned before, a symbol or visual indicator 604 may alert a user that the document having icon 600 is shared with other users. Beside this document icon 600 lies another icon 610 of another electronic file such as a sound or music file. This file having icon 610 may also indicate its name 612 and file type below the icon 610 of the file. The music file 610 has two comments associated therewith, which are indicated by a visible symbol 614 containing the number of comments that shared users have associated with file 610. As will be discussed below, users sharing a file or a collection of files in a folder may review comments or annotations associated with the files that have been shared with them.

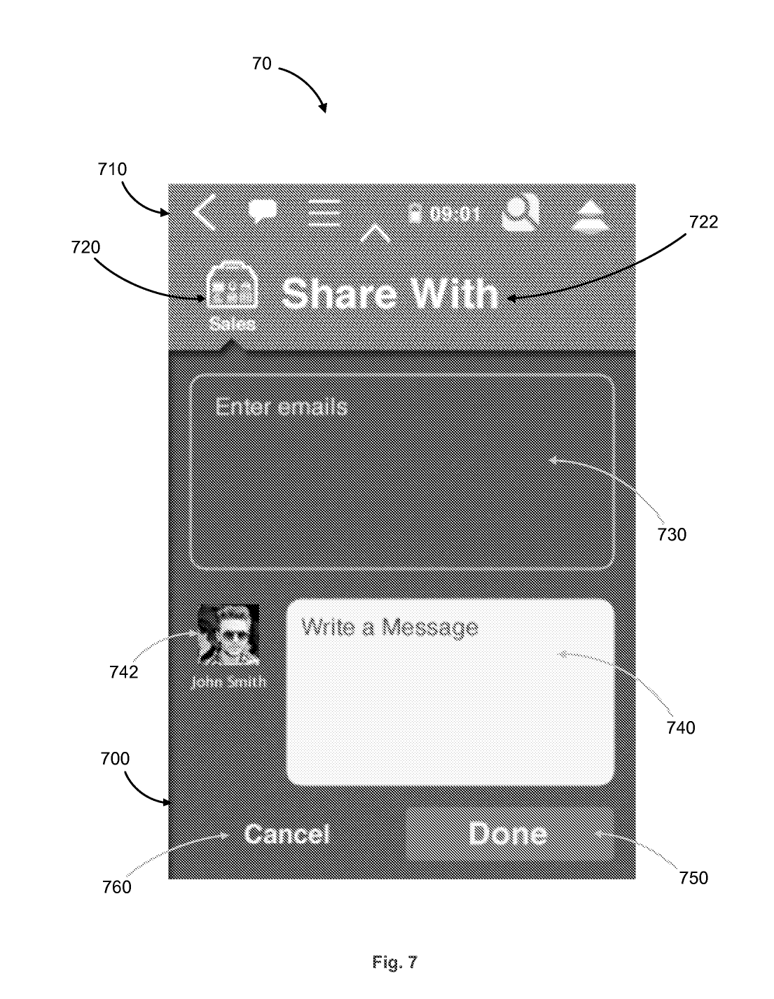

FIG. 7 illustrates a portion of a user interface screen 70 including a region 700 of the display indicating the details of the sharing of a folder among some user interface. Specifically, the user interface portion 70 shows an icon 720 of a folder in this example named “sales.” The user interface invites the owner of the file or the folder 720 to share this and presents a message 722 indicating that this folder 720 could be shared. Other user interface features are arranged at 710 in the user interface portion 70 and may be selected or clicked or otherwise interacted with by the user.

In this example, the owner of the folder 720 may enter one or more electronic mail addresses or select the same from an address book and enter these into a email entry portion 730 of the user interface. In addition to entering the email addresses of friends or colleagues with which the owner intends folder 720, the owner may write a message to the recipients indicated in box 730. The message may be typed into a text entry box 740 for example alerting the recipient to the existence of or the significance of the content being shared with them. Other visual cues such as profile names or photos 742 may be presented in the portion of the user interface 70. Buttons or other selectable user interface elements may allow the user to indicate when done 750 or to cancel the operation at 760.

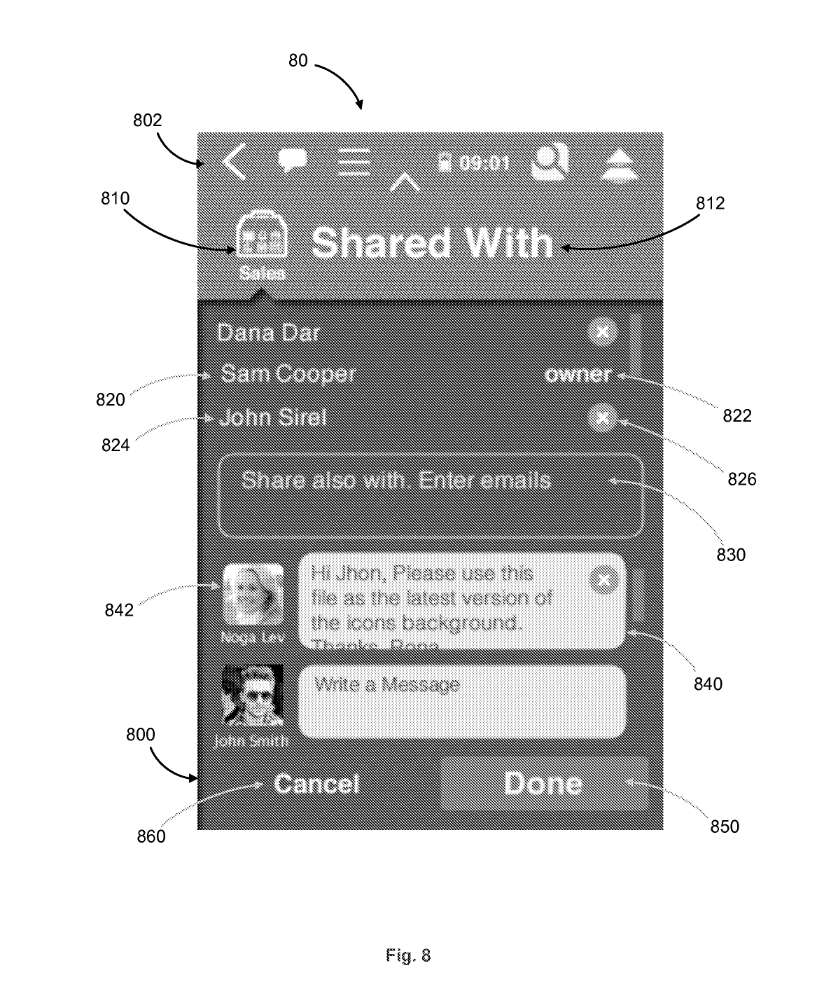

FIG. 8 illustrates an exemplary portion of a user interface 80 on a portion of a display screen 800 showing details of a shared folder or other electronic content. An icon 810 of a shared folder, in this example, named “sales” is displayed. As mentioned earlier, one or more user interface elements that may be selected by the user are shown for example in a row of user interface icons 802. The status of the shared folder 810 is displayed at 812 indicating that is has been shared with one or more recipients. Beneath that, the portion of the user interface 80 displays the name 820 of the owner of the shared folder or files and indicates this at 822. One or more recipient names 824 are also shown as well as an icon 826 allowing the owner of the shared content to delete or remove a recipient 824 from the list of shared users. An email entry box 830 is presented to allow the owner to share the folder 810 with yet other friends or associates. In addition, profile photos 842 and/or names of various other users sharing the content are displayed in the user interface portion 80. Comments or annotations by one or more of the shared users may be shown in respective textboxes 840. Again, the user may indicate at 850 that he or she is done or may cancel at 860 from this step of the process.

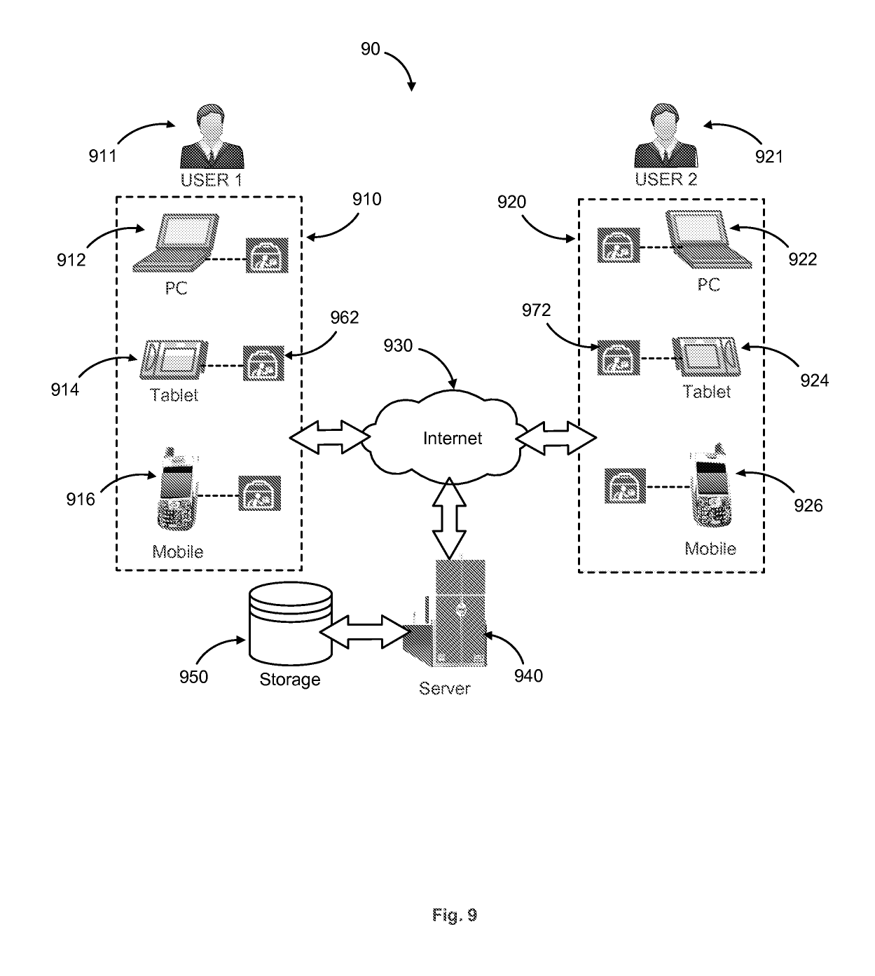

FIG. 9 illustrates an exemplary architecture 90 on which one or more present embodiments may be built. A plurality of users (e.g., USER 1 911 and USER 2 921) may be members of an enterprise. The users 911, 921 may be friends, collaborators or others who are interested in sharing files, folders or electronic objects and corresponding and annotating their interactions as described above. Each user has computing and personal communication devices in a user environment. USER 1 911 has a device environment 910 includes a mobile (for example a smartphone) 916, a tablet computing device 914 and a personal computer PC 912. USER 2 921 owns a device environment 920 that also includes some of the same or similar devices 926, 924 and 922, but each user may use a different universe of such devices. Other devices than those recited above may also be implemented of course, such as computing machines, processors, wearable devices, personal assistants, communicators and so on, but the present example is for illustrative purposes.

The users, through their device environments 910, 920 are connected to other computing and/or processing and/or storage apparatus infrastructure. For example, the user environments and their devise are connected over a network like the Internet 930. In turn, the network provides access to a server 940. The server may include or be connected (directly or indirectly) to storage 950 such as a database or memory apparatus.

Here, each user device includes a user experience feature and subsystem. The user experience subsystem can provide an interactive and dynamic user interface element (e.g., 962, 972) like that described above. These user interface elements, which can include a visible and interactive icon indicate the status of an electronic thing (file, folder, object). The electronic thing is here a shared thing that the users can review, modify and add annotations to. The user interface elements are dynamically updated to alert and indicate the status of the associated electronic thing they represent. For example, a shared electronic file causes an associated icon or indicator badge to be updated whenever any of the shared users makes changes or updates or annotations or comments thereto. The other users of the shared thing will be advised of this change or update without the need for a message to be sent to them relating to the change or update or annotation.

In an aspect, the present shared comments are associated with a particular file, folder or other shared data object (collectively “files”). In another aspect, the indications of a new shared message or comment are associated visually with the shared file by placement of the icon for the shared comment(s) on or beside the actual icon for the shared file. This can better indicate to the user which files have had new comments shared, unlike placing such notifications in a notification bar and unlike placing such notifications on the icon for an application program (or app), but rather by placing such notifications on or at or by the actual individual file/folder/object (“shared electronic file”) to which the comment belongs. In yet another aspect, the electronic file is not altered by the addition of the commentary to the file, but rather, the comments are separate from the file itself and are out-of-file instead of being in-file so as to allow any kind of electronic object to be tagged with comments instead of needing to modify a limited type of files with comments therein.

The exemplary arrangement or architecture above can be used for carrying out the present invention. Users may connect to their work environment by an app that they download to their device. When entering the app, they discover their organization work environment. The work environment is independent and designed differently per user/employee. The IT manger of the enterprise organization or the user himself can modify the environment.

In some aspects, the work environment might not be located on any of the devices, but can be virtualized. In FIG. 9 both users 911, 921 have or operate local or mobile devices as described in their device environments, and the devices may be based on an operating system, e.g., Andriod®, Apple iOS®, Windows® or others. The devices may run program instructions providing a “player” application (presenting the display screen or portion thereof that the users see on their devices) which is in fact a mirror that shows a virtual device environment that is located on server 940. Therefore, an operating system (e.g., a mobile operating system) can be installed on the server 940, simulated thereon, or executed in part thereon. The player that shows the environment on the devices is communicating by the UX over IP protocol from the server. A proprietary IP protocol may be also implemented to achieve the exchange of data to enable the present method.

The examples given herein are not intended by way of limitation of course. Many other equivalent and similar implementations may be implemented by those skilled in the art to include the present features.

In some embodiments, a new-shared file or folder or new comment can be stored on storage means 950 and is provided from storage 950 to server 940 and passes through the network 930. The users 911, 921 see the changes or annotations/comments inside their user interface elements 962, 972. The user interfaces are dynamic, interactive, and also are associated with an electronic object or record such as a file or folder that sharing users can make changes to, e.g., without needing to send an actual message to the other sharing users advising them to obtain or review the changes. Annotations are likewise dynamically reflected in the state of the user interface element and the users can each interact with the user interface object associated with the electronic object or record concerned.

In an aspect, the files or groups of files or folders or other electronic documents or machine readable data (collectively referenced herein as files or folders for simplicity) are dynamically updated. A user may view a file in a viewer on the user's device (e.g., computer or smartphone) and if the file is shared, the system automatically updates the shared and/or comment indications on the other members of the sharing group's displays to show the edit. A new comment by a user will be pushed to other users in the sharing group to alert them to the annotation or comment. An annotation or comment may be displayed in a dialog box on a user's device display unit. The annotation or comment can be in the form of a text message, e.g., containing alpha numeric letters, numbers, foreign characters, ASCII symbols, graphics or other communicative marks.

According to some embodiments, the user can point to, hover over, indicate or press a touch-sensitive portion of their device display units to access information about the details of the edit or changes in the sharing status of the file or folder. The sharing status and/or comment status corresponding to a file or folder may be stored in computer-readable instructions in a database or file management server or locally on each of the devices associated with the shared item. This allows for synchronizing the status information or the version information relating to a shared file or folder.

In some aspects, a user's local device (e.g., computer or communication device or smartphone) can include an “Inbox” associated with shared files or folders. The Inbox is updated and is responsive to input from the user interacting therewith through a user interface. An output responsive to the user's input gives the user an output (usually visual but not limited to visual output) indicative of a status of the shared item.

In other aspects, the user can touch the icon for (clicking or double clicking) or another user interface input element causing the item touched (e.g., a file or a folder) to be displayed to the user on his or her visual display unit. The visual display unit may be a monitor, LCD display, LED display or other display, sometimes including a touch-sensitive layer to accept tactile input.

According to an aspect, the icon for a shared item will return to its original form once a user reads any previously-posted comments or annotations to the shared item. Meaning, the icon includes an indicator that shows the presence of, and optionally the number of unread comments to the shared item. Then, when the user reads or deletes or accepts the shared comments, the icon is indicated to not have unread or new annotations or messages associated therewith.

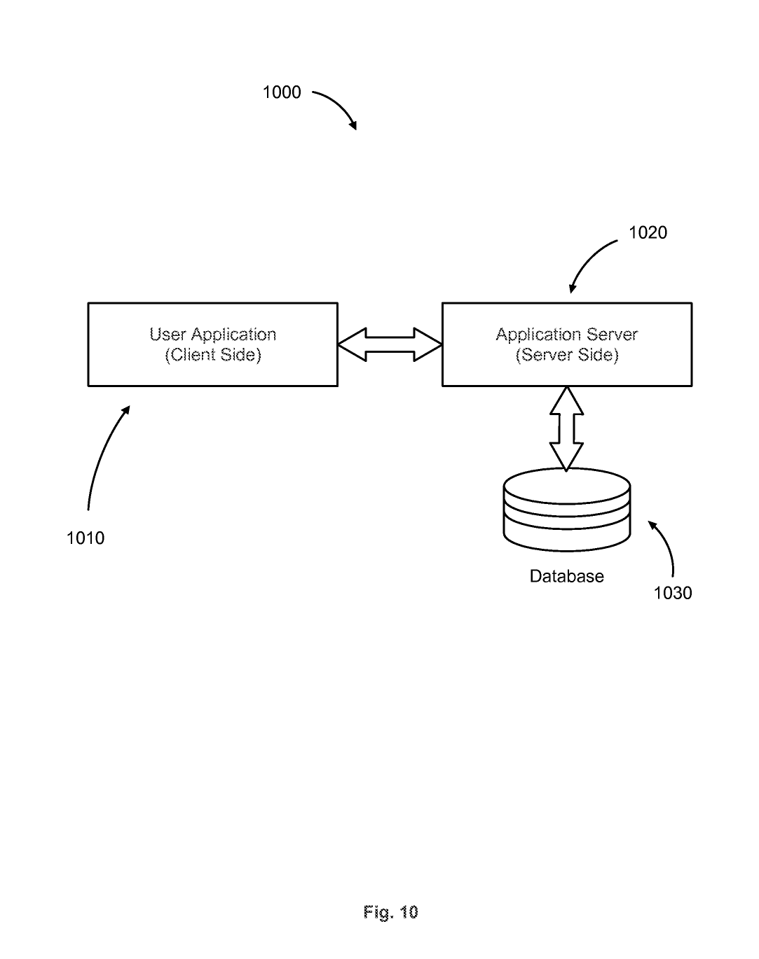

FIG. 10 illustrates a simplified client-server architecture 1000 for implementing the invention. The user side or client side is represented by a user application 1010, which can be hardware, software and/or firmware implemented in a client device such as a mobile computing device, smartphone, or similar apparatus. The server side can be represented in an application server 1020, which may further include or be coupled to a database 1030, which in turn may employ a database server in some instances. Information for execution of the steps of the present method can be programmed into or stored on non-transitory or other computer or machine readable media in the client and server sides of the system.

As stated elsewhere, the present system and method can be implemented by using some client-side and some server-side technologies in addition to an assortment of communication means, storage units and other ancillary features.

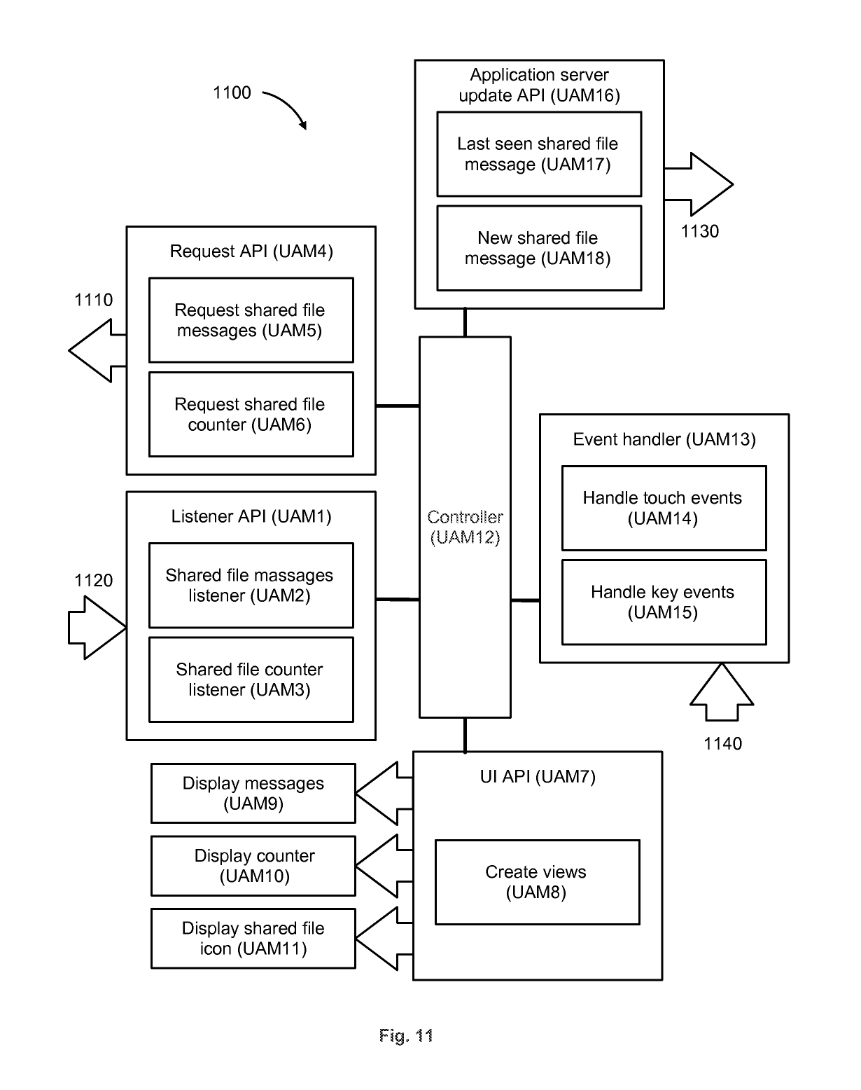

FIG. 11 illustrates an exemplary configuration of client-side user application modules 1100 of the system. This example is only for the purpose of illustration and those skilled in the art will appreciate other ways of implementing the details of such a system to suit a given need. It was discussed already that in an aspect, each shared electronic file is made available to a plurality of users that share the electronic file. The “electronic file” notion herein is considered to include any of a conventional computer file such as an application file, a media file such as audio, image/video, multimedia file, or a folder containing one or more such files and objects that can be stored, processed and shared on user devices. The controller UAM12 is in communication with the main modules of the user application system 1100.

The user application modules 1100 include a controller UAM12, e.g., a processor that can process machine readable instructions and execute the same, as well as process and manage data needed by the system. A Request application program interface (API) UAM4 sends requests 1110 to the server and includes request shared file messages module UAM5 and request shared file counter module UAM6.

A Listener API UAM1 receives incoming responses from the server and includes a shared file messages listener UAM2 and a shared file counter listener UAM3 to register the received message content information and unread message counts.

An application server update API UAM16 delivers updates 1130 to the application server. This module includes last seen shared file message module UAM17 and new shared file message module UAM18.

An event handler UAM 13 handles events relating to the user interface of the client device. This can take many forms, but in some embodiments the touch screen portion of a display unit supports handling of touch events in UAM14 and handling key stroke events in UAM15. Events 1140 are received by this module.

A user interface (UI) API UAM7 is also included to generate views in module UAM8, which can output display messages UAM9, display counter UAM10 and display shared file icon UAM11.

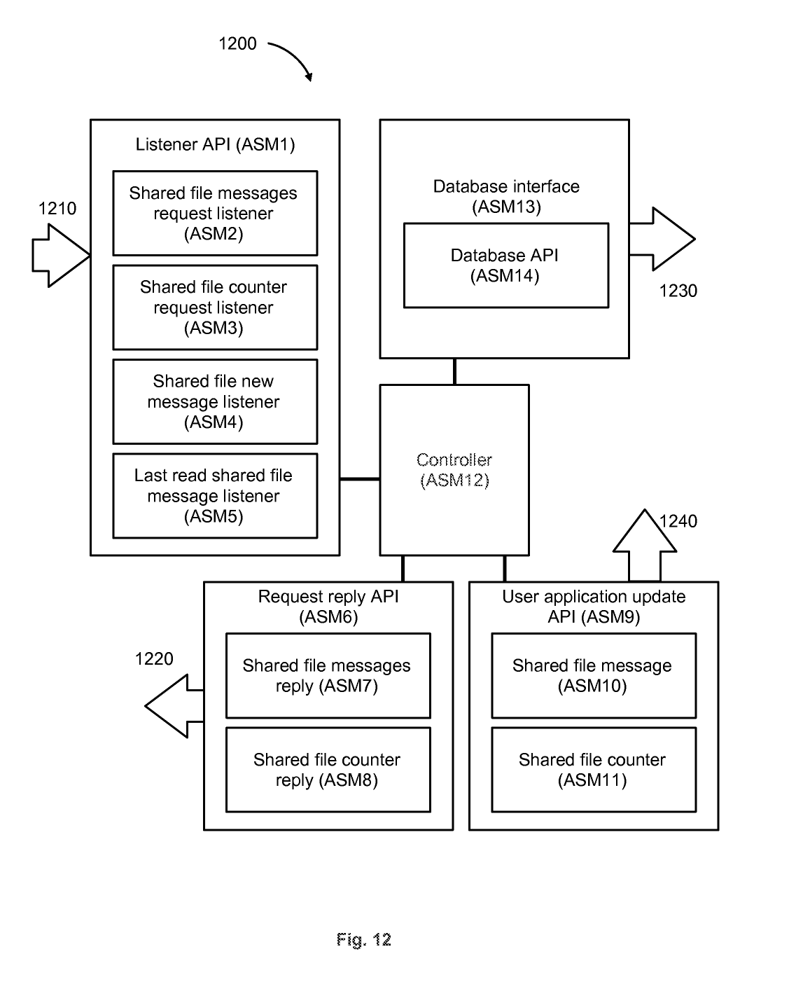

FIG. 12 illustrates server-side application server modules 1200 according to an exemplary and non-limiting embodiment of the present system. The server modules can generally service a plurality of client user requests and responses, and generally support a database with appropriate data structures and records to keep track of the various users, which files they have shared, and the status and time stamp and update information for each shared file for each such client user. The server modules 1200 include in this example a controller ASM12 that can process and manipulate data and instructions, including machine readable and/or computer-executable program instructions. The controller ASM12 is in signal communication with the various modules of the application server system.

A database interface ASM13 provides connectivity to a data store or database, optionally employing some database management or database server system. There is a database API ASM14 facilitating database calls 1230 and responses.

A user application update API ASM9 includes a shared file message module ASM10 and a shared file counter module ASM11, which send updates 1240 of shared message content information and message count regarding unread messages particularly relating to one or more shared electronic files. Again, an electronic file herein can include any type of electronic computer file, folder of files, media objects and so on that can be shared among a plurality of users.

A request reply API ASM6 includes a shared file messages reply module ASM7 and a shared file counter reply module ASM8 that generate and send replies 1220 to the client modules described earlier.

A listener API ASM1 receives incoming data 1210 from one or more clients. The listener API ASM1 includes a shared file messages request listener module ASM2, a shared file counter request listener module ASM3, a shared file new message listener module ASM4 and a last read shared file message listener module ASM5.

In an aspect, the database connected to the application server is used to manage data structures facilitating tracking of the status of shared electronic files. For example, the database can contain tables of client users using the system. The database can also contain tables of which electronic files or objects are being shared among which users. Additionally, the database can be used to hold tables tracking the last updates regarding the messages associated with each particular one of the shared files. In an aspect, the updates include time stamp information that indicate when a user last checked the shared messages pertaining to a particular shared electronic file.

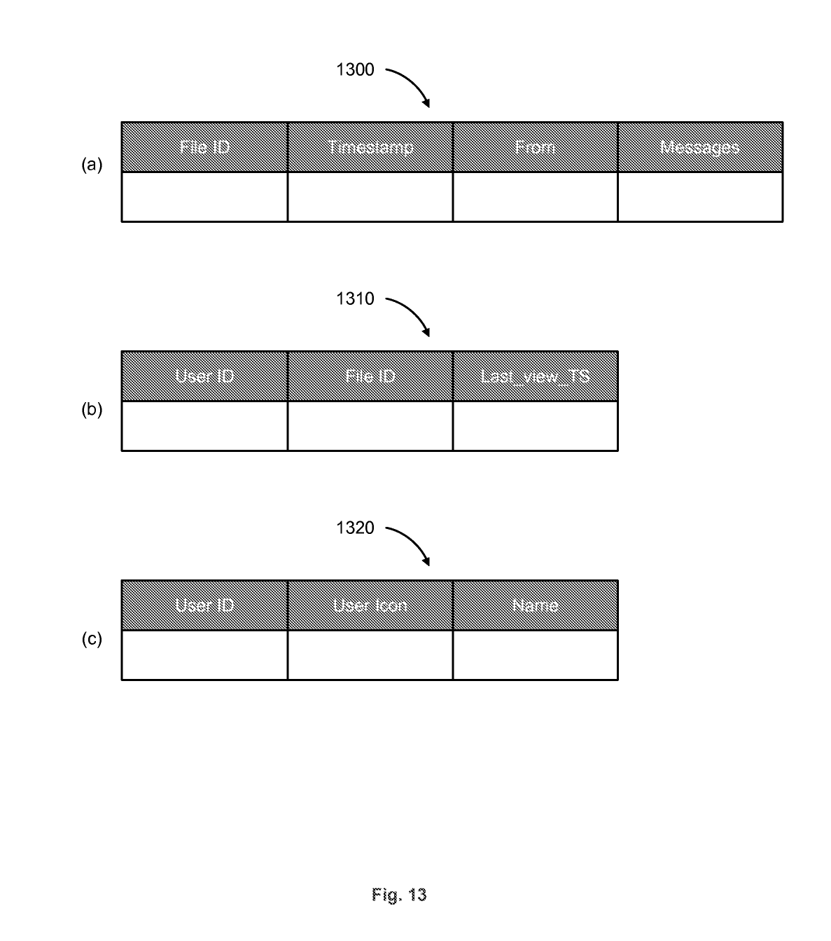

FIG. 13 illustrates exemplary tables of information that are housed in a database to facilitate tracking shared file status and message information as well as time stamp and unread message count information.

FIG. 13(a) represents a file messages table 1300 according to an example. The table contains a File ID that uniquely identifies shared electronic files having messages or updates associated therewith. The Timestamp is set by the application server upon updating this field in the database. The From indicates a unique key of a user the message is from. The Message indicates the message content information of a shared message relating to a particular electronic file.

FIG. 13(b) represents a messages user views table 1310. The table includes entries for a User ID indicating a user who has viewed messages of a shared file, a File ID indicating the shared electronic file, and a Last_view_TS that indicates the time stamp of the last time the viewer viewed the comments associated with the file.

FIG. 13(c) represents a user table containing the icon data and credentials of each user of the shared electronic file. The table includes a User ID of a user of the shared file, a User Icon, which is the icon representing the user, and the name of the user.

As would be understood by those skilled in the art, the above examples and discussion illustrate a new and useful method and system for sharing electronic content. The nature of the electronic content is general and may include electronic files, documents, multimedia content or other collections of files and information. It can be seen that the shared electronic files (application files, data objects, media files, folders of objects) can be annotated neatly with a type and quantity of shared comment indications, which include in some aspects the number of unread comments made to a shared electronic file waiting for the user to see. The user can then select, click on, or otherwise open the shared comments relating specifically to the shared electronic file in question.

Here, the user can see for each shared electronic file with specificity what and how many comments have been posted to this thing. So unlike email or message applications that indicate a generalized number of unread messages to the user, the user can see for each shared file whether and how many comments are associated with this particular file.

Also, to the extent that conventional file sharing systems permit shared commentary, these would include shared commentary within the body of the shared file itself thereby contaminating or infecting or otherwise modifying the shared file. In the present scenario, the file is not so affected, but the comments and indication of the comments and status and number of comments are associated with the shared electronic file and handled as described above.

As can be seen and understood, the present method and system permits flexible, useful and easily accessible sharing of electronic content as well as annotation of the same by way of comments made and shared among users in real time. The presence of comments or annotations associated with the shared content is clearly and substantially immediately apparent to those sharing the content because of the visible icons and indicators showing the status of a shared file or folder or content. Specifically, the sharing status is indicated to all shared users of a file and in addition the number of pending comments associated with such content is easily and immediately recognizable by the persons sharing the content. Moreover, the persons involved in a group sharing or collaborating on such shared electronic content may easily add their own comments or annotations associated with the content to be promulgated to the other users.

The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure. The claims are intended to cover such modifications and equivalents.

What is claimed is:

1. A system for sharing an electronic file comprising:
a visual display unit including a visual display area for displaying a user interface;
a portion of said visual display area including a display of an icon of a shared electronic file;
wherein said portion of said visual display area further displays a visual indicator of a sharing status of said electronic file or folder; and
wherein said indicator of said sharing status visually indicates a quantity of unread comments specifically associated with said shared electronic file.

2. The system of claim 1, further comprising a touch-sensitive portion of said visual display area corresponding to said icon.

3. The system of claim 2, further comprising machine readable instructions in a storage medium responsive to a touch of said touch-sensitive portion that display contents of said unread comments on said visual display unit.

4. The system of claim 3, further comprising machine readable instructions in said storage medium that reset said quantity of unread comments to zero after the display of said contents on said visual display unit.

5. The system of claim 1, wherein said electronic file represents a computer application file.

6. The system of claim 1, wherein said electronic file represents an electronic media file including an audio file or an image file.

7. The system of claim 1, wherein said electronic file represents a folder containing one or more computer application files, media files, data objects or folders.

8. The system of claim 1, further comprising machine readable instructions in said storage medium that place said indicator on said visual display area in proximity to said shared electronic file to which the indicator is associated.

9. A method for sharing electronic content and comments made specifically relating to shared electronic files comprising:
displaying on a portion of a visual display unit an icon representing an electronic file being shared by a plurality of users;
displaying on said display unit an indicator of a sharing status of said electronic file; and
displaying on said display unit an indicator of a quantity of unread comments specifically associated with said electronic file.

10. The method of claim 9, further comprising receiving a user input relating to said icon when said user interacts with said icon on said display.

11. The method of claim 9, further comprising, responsive to said user input, providing a visual representation of the sharing status of said electronic file, and further providing contents of an unread comment specifically associated with said electronic file.

12. The method of claim 9, further comprising receiving a plurality of comments from a plurality of users sharing said electronic file, storing said plurality of comments in connection with said electronic file, and transmitting signals to respective devices of said plurality of user indicative of an updated sharing and comments status of said electronic file.

13. The method of claim 12, said signals being transmitted using a push method so that said status is updated automatically without said users needing to log in to a service in order to view any status.

14. The method of claim 13, further comprising clearing a shared comments indicator after a user dispenses with or reads any such comments associated with the shared file.

15. The method of claim 9, further comprising associating said unread comments with said shared electronic file without altering said electronic file itself, and placing said indicator of unread comments in visual proximity to an icon of said shared electronic file itself.

16. A method for notification regarding comments associated with a shared electronic file, comprising:
establishing a data structure at a server, the data structure indicative of at least one shared electronic file shared among a plurality of client users and data relating to comments specifically associated with said shared electronic file;
receiving a comment from a first client, said comment containing comment content information and comment time stamp information specifically associated with said shared electronic file;
receiving from a second client a counter update request requesting a number of unread comments specifically associated with said shared electronic file;
sending to said second client a signal indicative of a number of said unread comments specifically associated with said shared electronic file;
receiving from said second client a request for at least said content information specifically associated with said shared electronic file;
sending to said second client said comment content information specifically associated with said shared electronic file; and
updating said data structure regarding said comments specifically associated with said shared electronic file to indicate that said comment content information was sent to said second client.
